(19) United States
(12) Patent Application Publication
(10) Pub. No.: US 2019/0164170 A1
(43) Pub. Date: May 30, 2019

(54) SENTIMENT ANALYSIS BASED ON USER HISTORY

(71) Applicant: International Business Machines Corporation, Armonk, NY (US)

(72) Inventors: Manish Kataria, New Delhi (IN); Amit Anil Nanavati, New Delhi (IN); Gyana Ranjan Parija, Gurgaon (IN)

(21) Appl. No.: 15/826,451

(22) Filed: Nov. 29, 2017

(51) Int. Cl. G06Q 30/00; G06Q 10/10

(52) U.S. Cl. CPC G06Q 30/016; G06Q 10/105

(57) ABSTRACT

One embodiment provides a method, including: accessing, for an identified individual, a sentiment profile comprising at least one average sentiment score, wherein the sentiment profile is generated by analyzing interactions of the identified individual with other individuals and wherein the sentiment profile reflects the identified individual's personality in interactions with other individuals; receiving input corresponding to a current interaction between the identified individual and at least one other individual; generating a current sentiment score for the identified individual corresponding to the current interaction using a sentiment analysis tool; determining a sentiment intent of the identified individual corresponding to the current interaction, wherein the determining a sentiment intent comprises comparing the current sentiment score to the at least one average sentiment score from the sentiment profile; and providing to a user, feedback of the determined sentiment intent of the identified individual.

### BACKGROUND

Sentiment analysis may be a useful tool for entities (e.g., corporations, individuals, groups of users, etc.) by providing a tool for identifying whether an interaction between two or more people was a positive, neutral, or negative interaction. Sentiment analysis may determine the attitude of an individual with respect to another object or user. The entity may use the identified sentiment to enhance future interactions with the same individuals. For example, if the sentiment analysis tool identifies an interaction as negative, the individual may contact the other individual to determine what part of the interaction caused the negative interaction and attempt to correct the identified problem. As another example, a corporation or other group may identify users that have negative interactions and keep those users from working on the same project to avert any disagreements or interactions that result in the productivity of the users decreasing. Similarly, for users that have positive interactions, the group may assign those users to the same project in order to enhance the productivity of the users.

### BRIEF SUMMARY

In summary, one aspect of the invention provides a method, comprising: utilizing at least one processor to execute computer code that performs the steps of: accessing, for an identified individual, a sentiment profile comprising at least one average sentiment score, wherein the sentiment profile is generated by analyzing interactions of the identified individual with other individuals and wherein the sentiment profile reflects the identified individual's personality in interactions with other individuals; receiving input corresponding to a current interaction between the identified individual and at least one other individual; generating a current sentiment score for the identified individual corresponding to the current interaction using a sentiment analysis tool; determining a sentiment intent of the identified individual corresponding to the current interaction, wherein the determining a sentiment intent comprises comparing the current sentiment score to the at least one average sentiment score from the sentiment profile; and providing to a user, feedback of the determined sentiment intent of the identified individual.

Another aspect of the invention provides an apparatus, comprising: at least one processor; and a computer readable storage medium having computer readable program code embodied therewith and executable by the at least one processor, the computer readable program code comprising: computer readable program code that accesses, for an identified individual, a sentiment profile comprising at least one average sentiment score, wherein the sentiment profile is generated by analyzing interactions of the identified individual with other individuals and wherein the sentiment profile reflects the identified individual's personality in interactions with other individuals; computer readable program code that receives input corresponding to a current interaction between the identified individual and at least one other individual; computer readable program code that generates a current sentiment score for the identified individual corresponding to the current interaction using a sentiment analysis tool; computer readable program code that determines a sentiment intent of the identified individual corresponding to the current interaction, wherein the determining a sentiment intent comprises comparing the current sentiment score to the at least one average sentiment score from the sentiment profile; and computer readable program code that provides to a user, feedback of the determined sentiment intent of the identified individual.

An additional aspect of the invention provides a computer program product, comprising: a computer readable storage medium having computer readable program code embodied therewith, the computer readable program code executable by a processor and comprising: computer readable program code that accesses, for an identified individual, a sentiment profile comprising at least one average sentiment score, wherein the sentiment profile is generated by analyzing interactions of the identified individual with other individuals and wherein the sentiment profile reflects the identified individual's personality in interactions with other individuals; computer readable program code that receives input corresponding to a current interaction between the identified individual and at least one other individual; computer readable program code that generates a current sentiment score for the identified individual corresponding to the current interaction using a sentiment analysis tool; computer readable program code that determines a sentiment intent of the identified individual corresponding to the current interaction, wherein the determining a sentiment intent comprises comparing the current sentiment score to the at least one average sentiment score from the sentiment profile; and computer readable program code that provides to a user, feedback of the determined sentiment intent of the identified individual.

A further aspect of the invention provides a method, comprising: utilizing at least one processor to execute computer code that performs the steps of: generating a personality profile for an individual, wherein the generating the personality profile comprises analyzing interactions between the individual and other individuals and wherein the personality profile comprises a plurality of attitude scores, each of the attitude scores corresponding to an attitude of the individual towards another individual; capturing input corresponding to a current collaboration between the individual and at least one other individual; creating, for the individual, an attitude score for the current collaboration; determining a current attitude of the individual by comparing the created attitude score to (i) the attitude scores within the personality profile that corresponds to the individual and the at least one other individual and (ii) an average attitude score of a group of individuals having at least one attribute matching the individual; and providing a notification of the current attitude of the individual.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of identifying a sentiment intent of a user for a current interaction.

FIG. 2 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

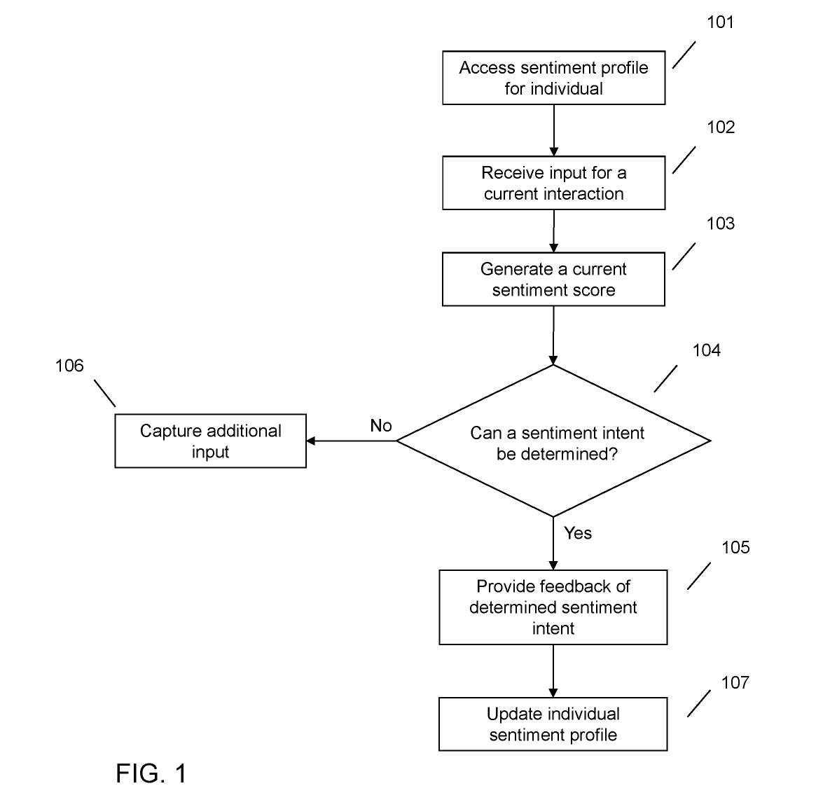

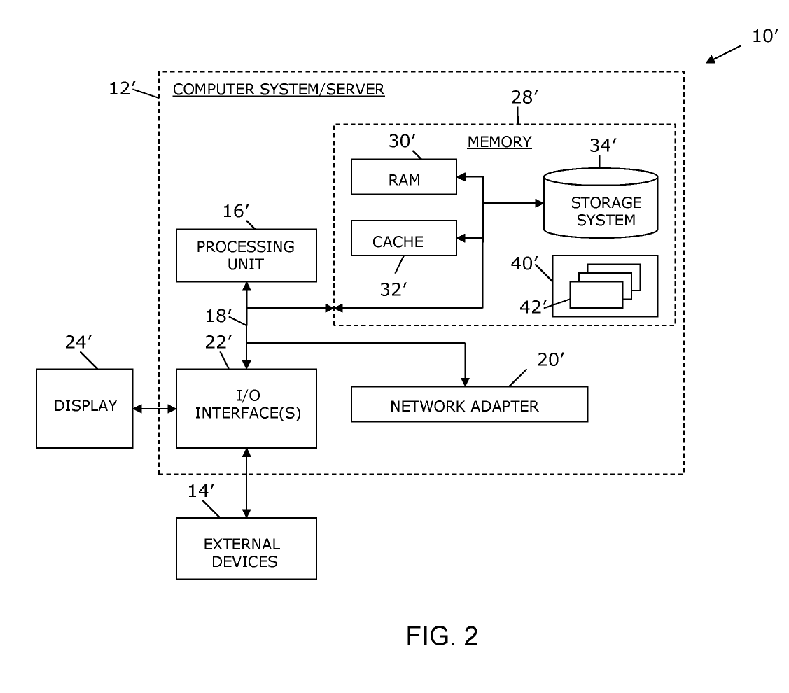

Specific reference will be made here below to FIGS. 1-2. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 2. In accordance with an example embodiment, all of the process steps, components and outputs discussed with respect to FIG. 1 can be performed or utilized by way of a processing unit or units and system memory such as those indicated, respectively, at 16′ and 28′ in FIG. 2, whether on a server computer, a client computer, a node computer in a distributed network, or any combination thereof.

Traditional sentiment analysis techniques use natural language processing, text analysis, computational linguistics, biometrics, or the like, to identify the attitude of an individual with respect to an object or other user. The problem with the traditional sentiment analysis techniques is that the sentiment analysis is generally performed without regard to a personality or history of a user. In other words, conventional sentiment analysis techniques do not account for the typical personality of the individual or a history that an individual may have with another individual. For example, if an individual is very direct, conventional sentiment analysis techniques may flag interactions with that individual as negative, even though the individual may have felt that the actual overall interaction with neutral or positive. As another example, if an individual is communicating in a language that is not native to the individual, the communication style may appear terse to a conventional sentiment analysis tool resulting in the tool identifying the interaction as negative even though none of the individuals involved in the interaction feel that it was negative.

These falsely labeled interactions or sentiments may result in ruined collaboration or relationships because some individuals may be tricked into believing that a positive relationship is being negative. Additionally, the falsely labeled interactions can result in action from a manager or other user who accesses the sentiment analysis associated with the interactions. The manager may see that a particular individual has a large number of interactions or relationships that are identified as negative and may take corrective action with regard to the employee, even though the employee may actually just be a direct person and may not actually be having negative interactions or relationships.

Additionally, conventional sentiment analysis techniques do not allow for identifying an average sentiment across an entire group of users. In other words, conventional techniques do not provide a mechanism to determine the overall or average sentiment of users within a group. The overall or average sentiment across a group of users may provide a mechanism for determining if a particular user has an issue interacting with other users or if the user is consistent with other individuals within the group. For example, a particular group of users may be part of a department that routinely interacts with angry or upset individuals, for example, a human resources department, a customer service department, or the like. Since this group of users deal with angry or upset individuals, conventional sentiment analysis techniques may provide sentiments for each individual user within the group. However, if the system could identify the overall or average sentiment for the group of users, the system may identify that the individual actually has a sentiment score that is comparable to the other individuals within the group.

Accordingly, the techniques and systems as described herein provide a sentiment analysis tool that can determine a sentiment intent of a user with respect to a particular interaction based upon a personality or overall attitude of the individual. The sentiment intent identifies an attitude or opinion of one individual to another individual or group of individuals in an interaction. In other words, the sentiment intent is a designation or description of the individual's intended attitude towards another individual during an interaction. For example, if the individual is typically a direct individual and during a particular interaction they are direct, the system may identify that this is a typical interaction from the individual and may then determine that the intent of the individual was neutral. Additionally, the techniques and systems as described herein provide a sentiment analysis tool that can identify an average or overall sentiment for a group of users that can then be used in identifying the sentiment for a particular user. The system may access or generate a sentiment or personality profile for an identified individual. The sentiment or personality profile may include one or more average sentiment scores, for example, an overall sentiment score, sentiment scores corresponding to particular individuals, sentiment scores corresponding to particular interactions, and the like. The sentiment profile or personality profile may identify or reflect an attitude or personal of the individual with respect to interactions with other individuals.

The system may receive input corresponding to a current interaction between the identified individual and at least one other individual, for example, in a collaborative environment. Using traditional sentiment analysis tools, the system may generate a current sentiment score for the individual corresponding to the interaction with the other individual. The system may then determine a sentiment intent or attitude of the user by comparing the generated sentiment score or attitude score to the scores within the sentiment or personality profile of the user. By comparing the generated sentiment score or attitude score to the sentiment or personality profile, the sentiment intent can be biased based upon an overall personality of the individual or an attribute of the individual. The system may also compare the generated sentiment or attitude score to an average sentiment score or collaboration score associated with a group of individuals having an attribute matching or similar to the individual. The system may then provide feedback regarding the sentiment intent or attitude.

Such a system provides a technical improvement over current sentiment analysis techniques. The systems and methods as described herein identify a sentiment profile for a particular individual which is then used to determine the actual sentiment of the user with respect to a current interaction. Rather than ignoring or discarding previous interaction information or attributes of an individual, the system as described herein uses that information to generate a sentiment profile for the individual. The system may then generate a more accurate sentiment intent for the user and current interaction. Additionally, the systems and methods as described herein provide a technique for identifying an average sentiment for a group of users that can be used to determine the actual sentiment of the user. In other words, the system as described herein provides a sentiment analysis tool that generates a more accurate sentiment intent, thereby resulting in fewer false positives or false negatives.

FIG. 1 illustrates a method for providing an analysis of sentiments unique to a particular user and based upon an overall attitude or personality of the user. At 101, the system may access a sentiment profile or personality profile for an identified individual. The sentiment profile may include one or more sentiment or attitude scores. For example, the profile may include an overall sentiment or attitude score for the individual, which may identify the overall personality of the user. As an example, if a user is a direct person and has direct interactions with other individuals, this may be reflected in the overall sentiment or attitude score. In other words, the profile may identify an attitude or personality of the user which may be used to identify sentiment intents of the user, as described in more detail herein.

The profile may also include one or more scores for particular individuals that the user may interact with. As an example, the user may be on friendly terms with a particular individual which may result in communications or interactions that are very informal and may include jokes, sarcasm, or other informal communications. The score associated with the interactions with that individual may reflect this typical interaction between these individuals. The profile may also include one or more scores for interactions between the individual and other individuals. For example, the last interaction that an individual had with another user may have resulted in a positive sentiment indication. Accordingly, the interaction score may indicate this positive sentiment. The interaction sentiment may also include an average sentiment score for interactions between the individual and another individual. In other words, the interaction score may not only be based upon a single interaction, but may instead or also be based upon all or a predetermined number of interactions between the individuals.

Thus, not only does the sentiment profile identify a particular sentiment, attitude, or personality of a person in general, but the sentiment profile also identifies a sentiment, attitude, or personality of a person as directed at another identified individual. In other words, the sentiment profile reflects that a person may have an overall personality or sentiment and also that the person may have a particular attitude or sentiment towards another person or group of individuals. It should be noted that the overall attitude of the person and an attitude of the person towards one or more individuals or groups of users may be different. For example, the individual may have an overall friendly and bubbly personality. However, the individual may have a more professional attitude when interacting with particular individuals or groups of individuals within the company that employs the individual. To further this example, the individual may have a different personality or attitude towards co-workers within the same company. Accordingly, it should be understood that the personality, opinion, or sentiment of the individual may be different towards different individuals and/or groups of individuals.

The term “score” will be used here throughout. However, it should be understood by one skilled in the art that a score does not necessarily correspond to a particular number or value. For example, a score may be an overall sentiment (e.g., negative, neutral, positive, etc.), personality attribute (e.g., direct, outgoing, friendly, aggressive, etc.), relationship identifier (e.g., friend, peer, associate, significant other, enemy, etc.), or may be a number (e.g., a number on a scale, range, etc.). In other words, the score may be any identifier that provides an indication of an attitude or sentiment of the user, interaction, or relationship between individuals that allows for more accurate identification of an intended sentiment of an individual.

The profile may be generated by analyzing interactions of the individual with other individuals. Not only can these interactions be analyzed to determine scores for individuals that the individual interacts with or interaction scores, but the aggregate of the scores or tendency of the scores can be used to assist in identifying an overall attitude, personality, opinion, or sentiment of the individual. The sentiment analysis of the individual interactions may be performed using traditional sentiment analysis techniques, for example, natural language processing, text analysis, computational linguistics, biometrics, or the like.

At 102 the system may receive input corresponding to a current interaction between the individual and at least one other individual. The current interaction may be an interaction in a collaborative environment, for example, social media Internet sites, professional collaboration environments, professional social platforms, or the like. The current interaction may also include interactions outside a collaboration environment, for example, communications between individuals (e.g., text messages, instant messages, emails, telephone calls, video conferences, etc.). A current interaction may include not only active interactions (e.g., an individual engaging with another individual, an individual sending a communication, etc.), but may also include possible interactions, for example, an individual selecting another user for communication (e.g., selecting the user in an instant messaging window, inputting the user in an email field, etc.).

The input corresponding to the current interaction may include communications between users, communications from an individual to a group of users, and the like. The input may not only identify that an interaction is occurring or may occur, but may also include information related to the communication that was exchanged or provided. In other words, the input corresponding to the current interaction may include any information that can be used by the system to identify the individuals involved in the interaction, determine a sentiment associated with the interaction, or the like. The input may also be of any input form, for example, text based input, audio based input, video based input, or the like. Depending on the requirements of the system, input provided using a different modality may be converted to an input form used by the system. For example, if the system uses text for analysis, audio or video input may be converted to text input.

At 103 the system may generate a current sentiment score for the individual and the current interaction. Generating the current sentiment score may include using traditional sentiment analysis tools or techniques as previously discussed. The current sentiment score may be based upon the input corresponding to the current interaction as captured or received at 102.

The system may determine if a sentiment intent or attitude of the user can be determined at 104. The sentiment intent or attitude may correspond to the sentiment intent or attitude of the user with respect to the current interaction. A sentiment intent or attitude may include an interaction intent of the user. For example, if a user is direct but intends the interaction to be a positive interaction, the system may determine this sentiment intent. The sentiment intent identifies an attitude or opinion of one individual to another individual or group of individuals in an interaction. In other words, the sentiment intent is a designation or description of the individual's intended attitude towards another individual during an interaction. For example, if the individual is typically a direct individual and during a particular interaction they are direct, the system may identify that this is a typical interaction from the individual and may then determine that the intent of the individual was neutral, even if the other individuals may think that the interaction was negative. Thus, the system takes into account the individual's natural personality and/or previous interactions to determine what the individual actually intended the overall sentiment of the interaction to be.

Determining the sentiment intent includes comparing the current sentiment score as obtained at 103 to an average sentiment score, or user benchmark sentiment score, as identified or stored in the sentiment profile. For example, the system may compare the current sentiment score to the overall sentiment score of the user. The sentiment intent analysis may also be based upon an interaction between the individual and a particular user. For example, if the user is interacting with a particular individual, the system may compare the current sentiment score to an average sentiment score associated with the individual. Similarly, the comparison may be based upon comparing the current sentiment score to an average interaction score. Alternatively, the comparison may include a comparison to one or more average sentiment scores. For example, the system may compare the current sentiment score to the overall sentiment score of the user, an average sentiment score associated with the user the individual is interacting with, and the average interaction score.

Determining a sentiment intent of the individual may also include identifying one or more attributes of the individual. For example, the system may identify that the user is communicating in a language other than a native language of the user, a geographic region of one or more individuals within the interaction, a department or group associated with the individual or other user, a culture of the individual or other user, or the like. Each of or a combination of these attributes may be used in determining the sentiment intent of the individual. For example, if an individual is communicating in a language other than the native language of the individual, the communications may appear more direct or brief. However, this may not necessarily mean that the interaction is negative. Accordingly, the system may take this attribute into account when determining the sentiment intent. As another example, when communicating with a user of another culture, the individual may communicate more formally to prevent miscommunications or misunderstandings. Again, this more formal communication may not mean that the interaction is negative. Accordingly, the system may take this attribute into account when determining the sentiment intent.

Determining the sentiment intent may include comparing the current sentiment score to a collaboration score associated with a group of individuals having one or more attributes matching or similar to the individual. For example, a group of individuals may include the individuals that work in the same department as the user. As another example, the group of individuals may include individuals within the same age range or of the same gender as the user. As an additional example, the group of individuals may include individuals that belong to the same social group (e.g., friends, study group, neighbors, activity group, etc.).

The group of individuals may have an associated collaboration score. This collaboration score may identify an average sentiment of the group, individuals within the group, sentiment between individuals, or the like. As an example, the collaboration score may be based upon the average sentiment score between users of the group, average sentiment scores of individuals within the group when interacting with individuals of another group, average sentiment score of individuals within the group when interacting in a particular language, average sentiment score of individuals within the group when interacting between different regions, or the like. The collaboration score or average group sentiment score may then be based upon an averaging of these different parameters. Not only may the parameters be selected by a user, for example, a manager of a department, a group leader, or the like, but weights associated with the parameters may also be selected by a user. For example, a user may decide that some parameters are not as important as other parameters. Accordingly, the user may reduce the weight associated with that parameter in order to minimize the influence of the parameter on the overall collaboration score.

Determining the sentiment intent, for example, whether the intent is positive, neutral, or negative, may be based upon a calculation by the system. In other words, the comparison of the current sentiment score to the average sentiment of the user and/or the collaboration score may include performing a calculation. As an example, a positive intent may be calculated by taking the average of the average sentiment of the user and the collaboration score (or only using the average sentiment score of the user in the case that the sentiment is not being compared to a group) and subtracting this value from the current sentiment score. If this value is greater than zero, the system may identify the sentiment intent as positive.

Similar calculations may be computed for negative intent and neutral intent, where negative intent is identified when the value is less than zero and neutral intent by identified when the value is equal to zero. The calculation may also take into account an average deviation, for example, with respect to the current sentiment score. In other words, the system may take into account a degree of uncertainty. As should be understood by one skilled in the art, this is merely an example and the intent may be computed or determined using different techniques, for example, by a direct comparison of the current sentiment to the average sentiment.

Upon determining a current sentiment score and/or sentiment intent, the system may update the profile with the additional or new information. If the sentiment intent cannot be determined at 104, the system may capture additional input at 106 that may be necessary for identifying the sentiment intent, for example, additional interactions between the individuals, additional correspondence between the individuals, or the like.

If, however, the sentiment intent can be determined at 104, the system may provide to a user, feedback of the determined sentiment intent at 105. Providing feedback may include one or more indications or outputs. For example, the system may simply notify (e.g., provide a pop-up window, send a communication to the individual, etc.) the user of the sentiment intent associated with the current interaction. Providing feedback may also include providing feedback to a third party. For example, if the system identifies that a particular user keeps having negative sentiment intents, the system may generate or provide a notification to a manager or group leader indicating that the individual is having negative interactions. Provision of this feedback may be based upon a predetermined number of negative interactions, a predetermined number of negative interactions occurring with a specified time period, or other threshold. This threshold may be a default threshold or may be selected by a user.

Providing feedback may also include updating an indication or icon within the collaborative environment or communication mechanism that reflects the determined sentiment intent. For example, in a social media system the feedback may be provided by sorting or identifying the sentiment intent associated with the users within the social media platform (e.g., changing an icon representing the individual to a different color, sorting the individuals by sentiment intents, placing a symbol on an icon representing the individual, etc.). It should be noted that the sentiment intent between users in an interaction does not have to be same for both individuals. For example, one individual within the pair or group may see the other user within the pair as a neutral sentiment intent, while the other user may see the individual as a positive sentiment intent.

The system may take additional actions based upon an identified sentiment intent for a user. For example, the system may prevent communications between the identified individual and other individuals if the system determines that sentiment intent is a negative intent. As an example, if a user is having a bad day as identified through sentiment intent analysis of interactions occurring through the day, the system may prevent the user from either sending or receiving communications. The system may also change privacy settings for the user. For example, the system may change a privacy setting of a communication mechanism to “Do Not Disturb” or “Offline” to prevent communications between the individual and other users.

The system may also discourage communication to the individual from another user. For example, if another user attempts to contact the individual, the system may provide a notification that now may not be a good time to contact the individual. In the case where the system prevents communication or alerts the user to not contact the individual, the system may provide a reminder that the user wanted to communicate with the individual when the sentiment score of the individual indicates the individual is in a better mood or has a positive intent.

The system may also delay sending a communication if the system identifies that the user may have a negative sentiment. For example, if the system determines that the user has a negative sentiment, the system may delay sending a communication from the individual to prevent possibly rash, harsh, or otherwise ill-advised communications. Delaying the communication may include delaying the communication until the individual has a more positive intent or for a predetermined length of time. Alternatively, delaying the communication may include increasing a delay feature of a communication mechanism, e.g., some email application delaying the sending of a communication for a certain length of time. If the system determines that the individual has a negative sentiment, the system may increase the length of delay for sending the communication.

Additionally, at 107, the system may also update a sentiment profile for each individual. For example, based upon the determined sentiment intents, the system may update the sentiment profile for each user included in the current interaction. Updating the sentiment profile may include updating the overall sentiment profile for a particular individual. Additionally, updating the sentiment profile may include updating the sentiment interaction profile corresponding to the users included in the interaction. In other words, as previously discussed, the sentiment profile may include an interaction score or profile that corresponds to interactions between identified individuals. This interaction score or profile may be updated to reflect the current interaction between these identified individuals.

As shown in FIG. 2, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
utilizing at least one processor to execute computer code that performs the steps of:
accessing, for an identified individual, a sentiment profile comprising at least one average sentiment score, wherein the sentiment profile is generated by analyzing interactions of the identified individual with other individuals and wherein the sentiment profile reflects the identified individual's personality in interactions with other individuals;
receiving input corresponding to a current interaction between the identified individual and at least one other individual;
generating a current sentiment score for the identified individual corresponding to the current interaction using a sentiment analysis tool;
determining a sentiment intent of the identified individual corresponding to the current interaction, wherein the determining a sentiment intent comprises comparing the current sentiment score to the at least one average sentiment score from the sentiment profile; and
providing to a user, feedback of the determined sentiment intent of the identified individual.

2. The method of claim 1, wherein the at least one average sentiment score corresponds to interactions between the identified individual and the at least one other individual.

3. The method of claim 2, wherein the determining a sentiment intent comprises comparing the current sentiment score to the at least one average sentiment score corresponding to interactions between the identified individual and the at least one other individual.

4. The method of claim 1, comprising identifying an attribute of the individual and wherein the determining a sentiment intent is based upon the identified attribute.

5. The method of claim 1, wherein the determining a sentiment intent comprises comparing the current sentiment score to a collaboration score associated with a group of individuals having at least one attribute similar to the identified individual.

6. The method of claim 5, wherein the group of individuals comprises a group of individuals within a department and wherein the department selects parameters used in generating the collaboration score.

7. The method of claim 1, wherein the providing feedback comprises updating an indication within a collaborative environment to reflect the determined sentiment intent.

8. The method of claim 1, comprising preventing communications between the identified individual and another individual if the determined sentiment intent is a negative intent.

9. The method of claim 1, comprising delaying sending of a communication from the identified individual if the determined sentiment intent is a negative intent.

10. The method of claim 1, comprising updating the sentiment profile for the identified individual based upon the generated current sentiment score.

11. An apparatus, comprising:
at least one processor; and
a computer readable storage medium having computer readable program code embodied therewith and executable by the at least one processor, the computer readable program code comprising:
computer readable program code that accesses, for an identified individual, a sentiment profile comprising at least one average sentiment score, wherein the sentiment profile is generated by analyzing interactions of the identified individual with other individuals and wherein the sentiment profile reflects the identified individual's personality in interactions with other individuals;
computer readable program code that receives input corresponding to a current interaction between the identified individual and at least one other individual;
computer readable program code that generates a current sentiment score for the identified individual corresponding to the current interaction using a sentiment analysis tool;
computer readable program code that determines a sentiment intent of the identified individual corresponding to the current interaction, wherein the determining a sentiment intent comprises comparing the current sentiment score to the at least one average sentiment score from the sentiment profile; and
computer readable program code that provides to a user, feedback of the determined sentiment intent of the identified individual.

12. A computer program product, comprising:
a computer readable storage medium having computer readable program code embodied therewith, the computer readable program code executable by a processor and comprising:
computer readable program code that accesses, for an identified individual, a sentiment profile comprising at least one average sentiment score, wherein the sentiment profile is generated by analyzing interactions of the identified individual with other individuals and wherein the sentiment profile reflects the identified individual's personality in interactions with other individuals;
computer readable program code that receives input corresponding to a current interaction between the identified individual and at least one other individual;
computer readable program code that generates a current sentiment score for the identified individual corresponding to the current interaction using a sentiment analysis tool;
computer readable program code that determines a sentiment intent of the identified individual corresponding to the current interaction, wherein the determining a sentiment intent comprises comparing the current sentiment score to the at least one average sentiment score from the sentiment profile; and
computer readable program code that provides to a user, feedback of the determined sentiment intent of the identified individual.

13. The computer program product of claim 12, wherein the at least one average sentiment score corresponds to interactions between the identified individual and the at least one other individual and wherein the determining a sentiment intent comprises comparing the current sentiment score to the at least one average sentiment score corresponding to interactions between the identified individual and the at least one other individual.

14. The computer program product of claim 12, comprising identifying an attribute of the individual and wherein the determining a sentiment intent is based upon the identified attribute.

15. The computer program product of claim 12, wherein the determining a sentiment intent comprises comparing the current sentiment score to a collaboration score associated with a group of individuals having at least one attribute similar to the identified individual.

16. The computer program product of claim 15, wherein the group of individuals comprises a group of individuals within a department and wherein the department selects parameters used in generating the collaboration score.

17. The computer program product of claim 12, wherein the providing feedback comprises updating an indication within a collaborative environment to reflect the determined sentiment intent.

18. The computer program product of claim 12, comprising preventing communications between the identified individual and another individual if the determined sentiment intent is a negative intent.

19. The computer program product of claim 12, comprising updating the sentiment profile for the identified individual based upon the generated current sentiment score.

20. A method, comprising:
utilizing at least one processor to execute computer code that performs the steps of:
generating a personality profile for an individual, wherein the generating the personality profile comprises analyzing interactions between the individual and other individuals and wherein the personality profile comprises a plurality of attitude scores, each of the attitude scores corresponding to an attitude of the individual towards another individual;
capturing input corresponding to a current collaboration between the individual and at least one other individual;
creating, for the individual, an attitude score for the current collaboration;
determining a current attitude of the individual by comparing the created attitude score to (i) the attitude scores within the personality profile that corresponds to the individual and the at least one other individual and (ii) an average attitude score of a group of individuals having at least one attribute matching the individual; and
providing a notification of the current attitude of the individual.
